(19) United States
(12) Patent Application Publication
(10) Pub. No.: US 2009/0087610 A1
(43) Pub. Date: Apr. 2, 2009

(54) INTEGRATED CERAMIC METAL IMITATION

(76) Inventor: Tsung-Hui Lee, Tau Yuan Hsien (TW)

Correspondence Address: Tsung-Hui Lee, 235 Chung - Ho, Box 8-24, Taipei, 235, TW

(21) Appl. No.: 11/864,878

(22) Filed: Sep. 28, 2007

(51) Int. Cl. B32B 15/04

(52) U.S. Cl. 428/76; 428/433

(57) ABSTRACT

An integrated ceramic metal imitation comprises a ceramic body; a metal element being engaged to the ceramic body; a metal layer adhered on outer surfaces of the ceramic body and the metal element so that the surface presents shine effect. The metal layer is formed by electroplating or electric sputtering or evaporation. The ceramic body is one of a sanitation device, a hook for dressing, a switch, a door handle, and a toothbrush frame. The metal layer is formed by electroplating or sputtering or evaporation. The ceramic body is one of a sanitation device, a hook for dressing, a switch, a door handle, and a toothbrush frame.

### FIELD OF THE INVENTION

The present invention relates to ceramic devices, and particularly to an integrated ceramic metal imitation which can present a shine effect on the surface thereof and may be formed with a shape of a sanitation device, such as a toothbrush frame. Furthermore, the present invention is matched to the requirement of environmental protection.

### BACKGROUND OF THE INVENTION

Ceramic material are widely used in many fields, in the ancient time, the ceramic material is mainly used in decorations, or home used tools, utensils, ceramic tiles, etc. However, nowadays, people find that the ceramics are capable of being used in more fields, especially, in a high technology.

Nowadays, the ceramic material can not completely substitute the metal material. This is because that shine effect of the ceramic material is not as good as metals. Thus there is a need for a novel design which can provide the ceramic metal with preferred shine effects so as to widen the application of the ceramic material to be used in more fields.

### SUMMARY OF THE INVENTION

Accordingly, the primary object of the present invention is to provide an integrated ceramic metal imitation which can present a shine effect on the surface thereof and may be formed with a shape of a sanitation device, such as a toothbrush frame. Furthermore, the present invention is matched to the requirement of environmental protection.

To achieve above objects, the present invention provides an integrated ceramic metal imitation comprises a ceramic body; a metal element being engaged to the ceramic body; a metal layer adhered on outer surfaces of the ceramic body and the metal element so that the surface presents shine effect. The metal layer is formed by electroplating or electric sputtering or evaporation. The ceramic body is one of a sanitation device, a hook for dressing, a switch, a door handle, and a toothbrush frame. The metal layer is formed by electroplating or electric sputtering or evaporation. The ceramic body is one of a sanitation device, a hook for dressing, a switch, a door handle, and a toothbrush frame.

The various objects and advantages of the present invention will be more readily understood from the following detailed description when read in conjunction with the appended drawing.

### BRIEF DESCRIPTION OF THE DRAWINGS

FIG. 1 is an exploded schematic view of the first embodiment of the integral formed metal imitation according to the present invention.

FIG. 2 is assembled views about the first embodiment of the present invention.

FIG. 2-1 is assembled views about the first embodiment of the present invention.

FIG. 3 is a schematic view about the second embodiment of the present invention.

FIG. 4 is a schematic view about the third embodiment of the present invention.

FIG. 5 is a schematic view about the fourth embodiment of the present invention.

FIG. 6 is a schematic view about the fifth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to an integral form metal decoration, which has a ceramic body. A surface of the ceramic body is processed so as to have a shine effect on the surface thereof.

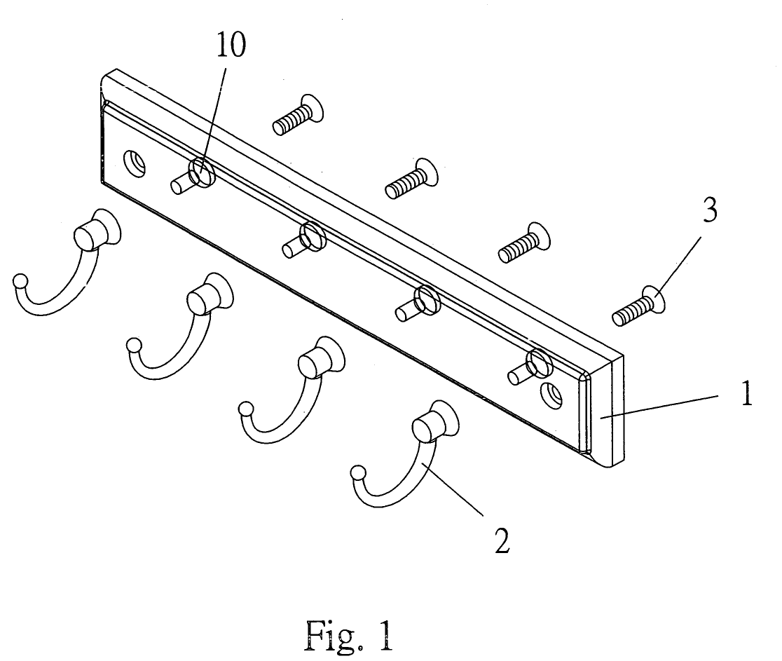

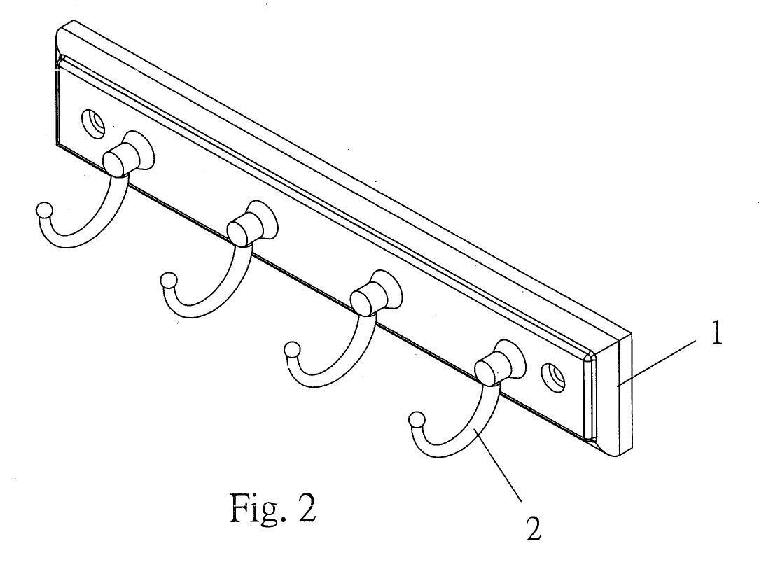

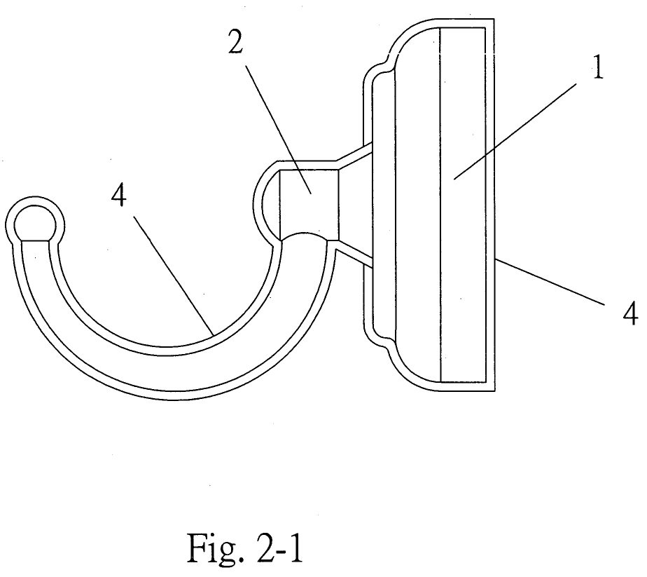

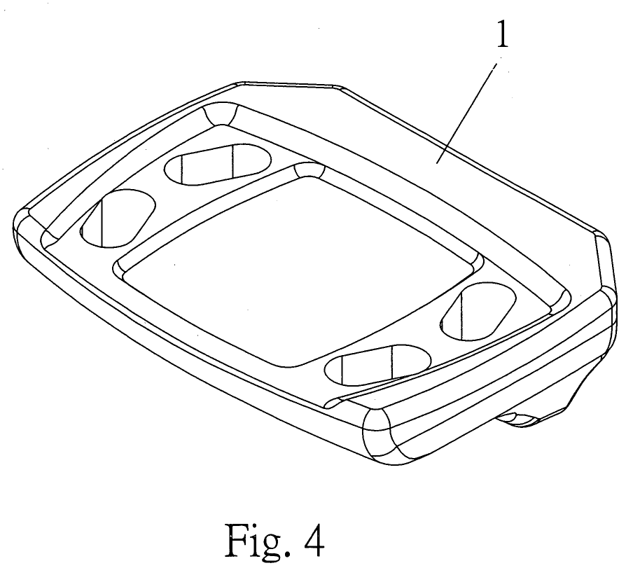

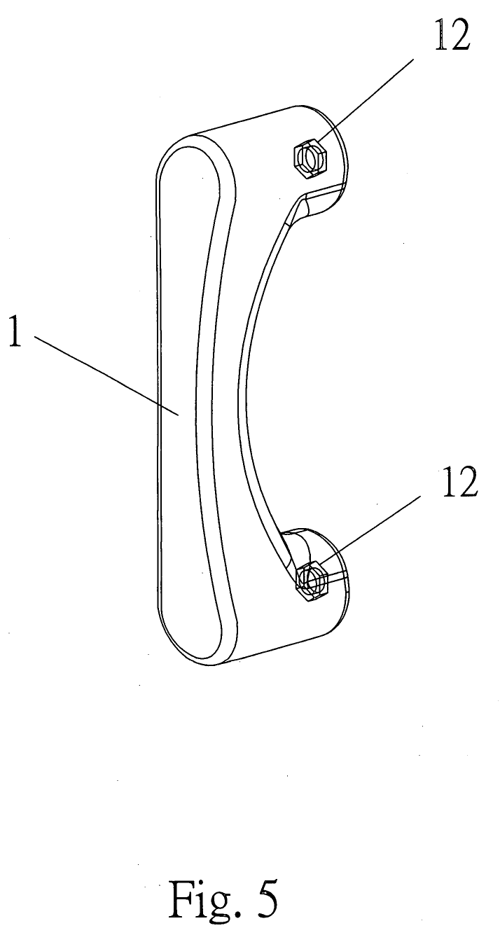

Referring to FIGS. 1, 2 and 2-1, a ceramic body 1 has an approximate rectangular shape. A metal element 2 is combined to the ceramic body 1 by using screws 3. The metal element 2 may be any kind of metal element 2. The surface of the metal element 2 is processed so as to form with a metal layer 4 which has a shine effect. Of course, as shown in FIGS. 4, 5, or 6, the ceramic body 1 may have a polygonal shape with a predetermined thickness. The shape of the ceramic body 1 is made as desired.

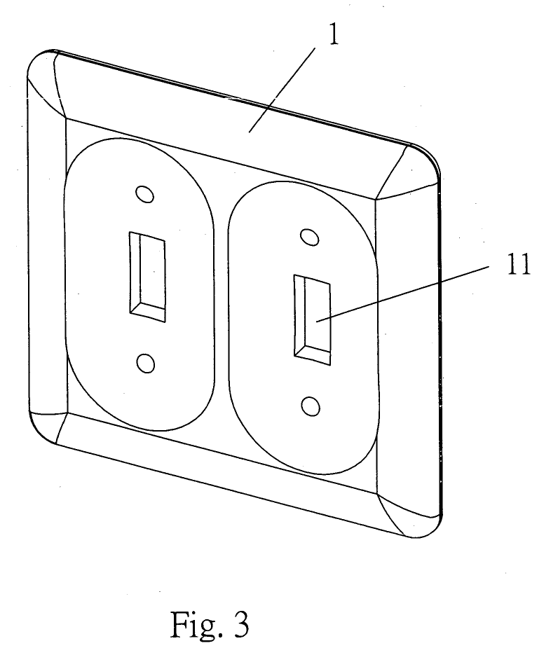

In the first embodiment of the present invention, the ceramic body 1 has a plurality of pores 10 and is combined with a metal element 2. The surface of the metal element 2 is processed so as to form as a metal imitation. The ceramic body 1 may be formed with a plurality of recesses 11, as shown in FIG. 3. The recesses 11 are sued as recesses of a power switch so that the ceramic body 1 is formed as a switch plate which can be suspended to a wall. Thus the switch has a beautiful outlook.

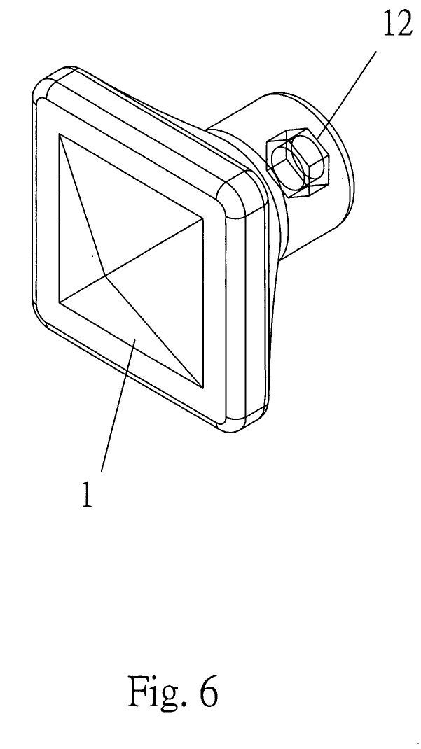

Besides, as shown in FIG. 4, the ceramic body 1 may be formed with a shape of a sanitation device, such as a toothbrush frame. Moreover, metal nuts 12 can be engaged to the ceramic body 1. The surface thereof is processed so as to form as an integral metal imitation, as shown in FIGS. 5 and 6.

It should be noted that the present invention is matched to the requirement of environmental protection.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An integrated ceramic metal imitation comprising:
a ceramic body;
a metal element engaged to the ceramic body;
a metal layer adhered on outer surfaces of the ceramic body and the metal element so that the surface presents shine effect.

2. The integrated ceramic metal imitation as claimed in claim 1, wherein the metal layer is formed by electroplating or sputtering or evaporation.

3. The integrated ceramic metal imitation as claimed in claim 1, wherein the ceramic body is one of a sanitation device, a hook for dressing, a switch, a door handle, and a toothbrush frame.
